(19) United States
(12) Patent Application Publication
(10) Pub. No.: US 2009/0101554 A1
(43) Pub. Date: Apr. 23, 2009

(54) Filtering Device and Method for Its Manufacture

(75) Inventors: Anton Kreiner, REISBACH (DE); Norbert Strassenberger, ADLKOFEN (DE); Bernd Buchner, FRONTENHAUSEN (DE); Anton Rabanter, STEINBERG (DE)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/253,408

(22) Filed: Oct. 17, 2008

(30) Foreign Application Priority Data
Oct. 19, 2007 (DE) 10 2007 050 525.8

(51) Int. Cl. B01D 35/30; B29C 59/00; B29C 45/14; B29C 65/02; B29C 65/16; B29C 59/06

(52) U.S. Cl. 210/167.08; 210/435; 210/232; 264/293; 264/248; 264/257; 264/405; 264/482; 264/509

(57) ABSTRACT

A filtering device has a filter cup made from plastic material, a filter element inserted into the filter cup, and a filter lid closing off the filter cup. At least one labeling surface is provided on the filter cup. The at least one labeling surface is a plastic film provided with at least one labeling and is applied to the filter cup by in-mold labeling.

### TECHNICAL FIELD

The present invention relates to a filtering device that can be used in particular as a disposable plastic filter, for example, as an oil or fuel filter for motor vehicles, and a method for manufacturing such a filtering device.

### BACKGROUND OF THE INVENTION

Disposable filters serve, for example, for filtering fuels or lubricants in order to prevent sludge formation in the respective lubricant circulation or contamination of the engine.

Conventional disposable oil filters are comprised of a robust metal housing or a filter cup into which a filter element is inserted. The oil to be filtered passes into the interior of the housing through one or several concentric openings provided in the lid, passes through the filter element, and exits in purified form from an opening of the filter or filter cup. Such filter housings or cups made from metal are stable but they have a considerable weight.

It is therefore desirable to manufacture such disposable filters from plastic materials in order to reduce weight; this causes at the same time a reduction in fuel consumption when such filters are used in a motor vehicle. The use of plastics in the manufacture of such filters however has disadvantages. While metal filters can be easily painted and provided with labels on their exterior, this is difficult in case of filter cups that are made from plastics. However, it is necessary to provide a respective oil filter or filtering device with labeling or markings.

Laser labeling is usually not possible because the employed plastics for producing such filters are made from laser-transparent material. Also, stamping with markings can be realized only with great expenditure because the surface to be stamped must be free of grease and therefore must be pretreated in order for the stamping ink or paint to adhere to it.

Hot embossing methods that are also often used for labeling plastic workpieces are not suitable for labeling filtering devices because the hot-embossed section weakens the filter cup wall so that, in order to provide a sufficient stability for a hot-embossed filter cup, more material for the filter cup wall is required. Hot embossing methods also lead to a cycle time reduction in the manufacturing process because the melted embossed sections must first cool down.

In view of these problems, it is an object of the present invention to provide an improved filtering device that can be manufactured as much as possible from plastic materials and that is provided with a labeling or marking that can be produced in an inexpensive and simple way.

### SUMMARY OF THE INVENTION

In accordance with the present invention the filtering device is comprised of a filter cup made from plastic material and a filter lid that closes off the filter cup and a filter element provided in the filter cup. The filter cup has at least one labeling surface with markings wherein the labeling surface is realized by in-mold labeling by using a plastic film provided with the markings. The labeling surface is provided, preferably on the exterior side of the filter cup, with a type designation, mounting instruction for the filtering device, a trade name or trademark, and/or a manufacturer label, for example.

Since the labeling surface is formed by in-mold labeling technology, in particular no problematic subsequent manufacturing step is created in the manufacturing process after the actual production of the filtering device. In the in-mold labeling technology, a decorated film, i.e., a plastic film with, for example, markings or labels printed on it, is inserted into the respective injection mold and the liquefied plastic material for the filter cup is then injected into the mold onto the film positioned in the mold. The injection-molded part, i.e., the filter cup of plastic material, is thus already provided with the markings after the injection molding process.

In addition to simple markings, it is moreover possible to embed into the film holograms or even integrated electronic chips. Such safety features enable, for example, a differentiation between original parts and plagiarized parts. Moreover, by this in-mold labeling process practically any desired labeling can be generated and such a labeling can also have different colors.

In a preferred embodiment of the filtering device the filter cup and the filter lid are welded together. This can be realized, for example, by laser welding because generally the employed plastic materials are laser-transparent. For example, a suitable material such as polyamide is oil-resistant and is resistant in a temperature range of −40 degrees Celsius to 150 degrees Celsius. Moreover, appropriate materials can be welded by conventional 800 nm lasers. Principally, the employed plastic material should be resistant relative to operating liquids of the motor vehicle.

The invention furthermore provides a method for producing a filtering device, for example, the afore described filtering device, that can be embodied as a disposable oil or fuel filter and that comprises at least a filter cup, a filter lid, and a filter element. In this connection, the filter cup is produced by an injection molding process and is provided by means of in-mold labeling with a labeling surface provided with markings.

As method steps, the following are envisioned: introducing a plastic film as a labeling surface into a mold for the filter cup, injecting a plastic material into the mold, and joining (fusing) the injected plastic material with the plastic film. Moreover, preferably a filter element is inserted and the filter cup is closed by the filter lid.

In a variant of the method, the plastic film is secured by means of electrostatic charging or by means of vacuum in a predetermined position in the mold. Depending on the employed plastic material for the filter cup or the plastic film, an electrostatic charging can be achieved so that the plastic film can be arranged in the mold in its exact position for creating the labeling surface. For certain plastic materials that exhibit hardly any electrostatic effects, for example, polyamide, it is possible to employ vacuum devices that generate vacuum or underpressure so that a plastic film will be secured by vacuum action.

The manufacture of a corresponding filtering device according to the described method has the advantage that in particular for the labeling no complex treatment of the surface of the filter cup is required. Moreover, the application of a marking or labeling can be realized in a simple way on components of any shape, for example, the round portion of the filter cup. Since for in-mold labeling the film will fuse with the plastic material of the filter cup, in this way also markings can be applied that comprise more complex elements, such as microchips. The in-mold labeling process is referred to also as in-mold surfacing or in-mold painting.

The proposed method has in particular the advantage that no pretreatment of the disposable plastic filter is required, a high color depth in comparison to conventional printing methods is possible and, in case of a model change or a change of the manufacturer label, the film can be changed without great expenditure, respectively. Moreover, the otherwise necessary production step that is required in particular in case of metal-based filter cups, i.e., the labeling after the completed manufacture of the filtering device, is no longer needed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 shows a cross-section of an embodiment of the filtering device according to the invention;

FIG. 2 shows a schematic flow chart of one variant of the manufacturing process for the filtering device according to the invention;

FIGS. 3A to 3E illustrate in sequence the method steps according to the invention for manufacturing the filtering device according to the invention, wherein FIG. 3A shows the film with labeling; FIG. 3B shows the mold with the film inserted therein; FIG. 3C shows the material of the filter cup injected into the mold; FIG. 3D shows insertion of the filter element and attachment of the filter lid; and FIG. 3E shows the completed filtering device.

In the Figures the same, or functionally the same, elements, if not indicated otherwise, are identified with same reference numerals.

### DESCRIPTION OF THE PREFERRED EMBODIMENTS

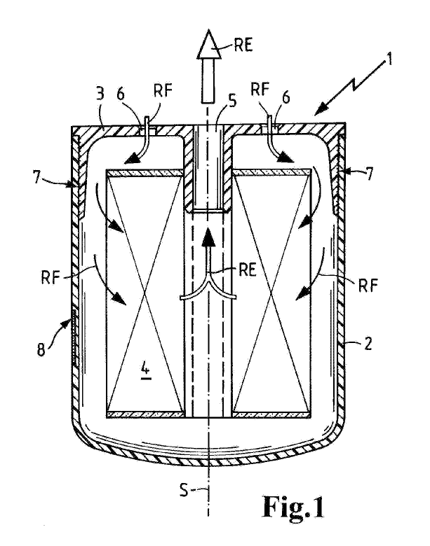

FIG. 1 shows a filtering device, for example embodied as an oil filter, in cross-section. The filtering device 1 has a filter cup 2 that is, for example, cylindrical and open at one end and into which the filter element 4 is inserted. The filter element 4 can be folded like an accordion and can be comprised of nonwoven filter material. In this connection, the zigzag-folded filter element surrounds, for example, a symmetry axis S and provides a boundary surface between an unfiltered liquid area and a filtered liquid area within the filter cup 2.

The filter cup 2 in the illustration of FIG. 1 is closed off at the top by a filter lid 3. The filter lid 3 has a central opening 5 and further openings 6 through which an unfiltered fluid, for example, motor oil, flows into the interior of the filtering device 1. This is illustrated by arrows RF. The oil to be filtered passes through the boundary surface that is constituted by the filter element material and exits through the central opening 5 in the filter lid 3 from the filtering device 1 as purified fluid RE. Other fluid or oil flows, for example, in opposite directions, are also conceivable.

Of course, further elements such as seals, hoses, terminal disks or stabilizing means can be provided in such a disposable plastic filter. FIG. 1 shows such a filtering device only schematically.

The filter cup 2 is produced from plastic material by way of injection molding. In this connection, a labeling surface 8 is provided that is formed by a plastic film and is created by means of in-mold labeling. The sections indicated by the arrows 7 at the upper circumferential rim of the filter cup 2 where the filter lid 3 rests are, for example, welded together. This can be done, for example, by laser welding.

A suitable material for the filter cup 2 and also for the filter lid 3, which material is resistant relative to the operating liquids of a motor vehicle, is for example polyamide. In particular polyamide PA6.6 that is reinforced by fiberglass can be used. By the addition of fiberglass, the plastic material is reinforced.

The filtering device according to the invention has e.g. the advantage of 50 percent reduction in weight relative to metal filters. Since such a filtering device is practically completely made of plastic material, it can be easily and simply disposed of by incineration. Also, the relatively soft plastic material can hardly damage a mounting flange on the respective motor vehicle when carrying out an oil filter change.

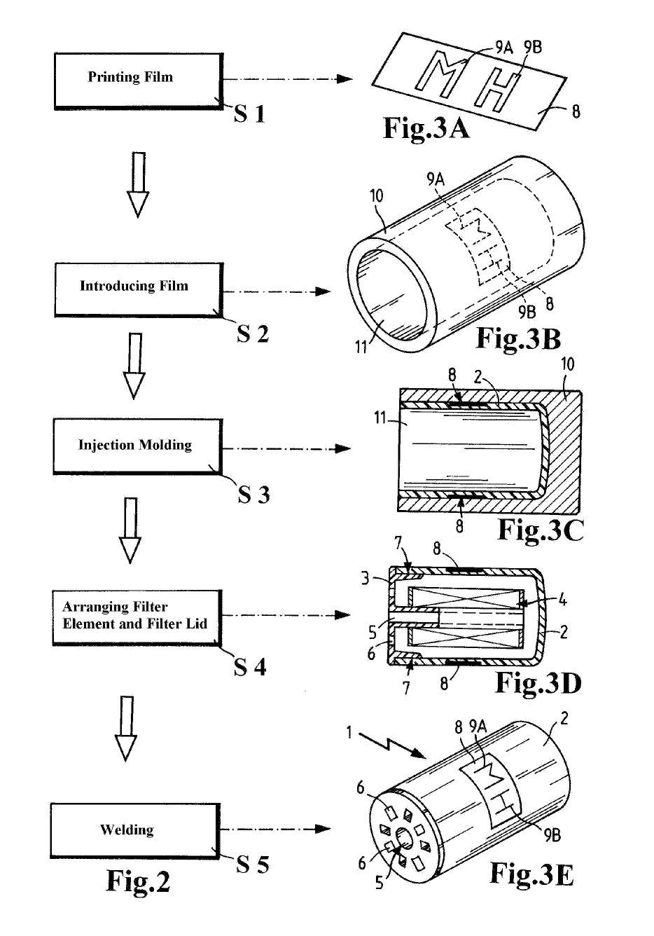

FIG. 2 shows as an example the course of method steps for producing a corresponding filtering device. In FIG. 3 the individual method steps are illustrated in more detail.

In the first method steps S1 suitable markings are printed on a film. The film is comprised preferably of the same material as the filter cup to be produced by injection molding or from a material that is compatible with the material of the filter cup. In FIG. 3A the plastic film that represents the labeling surface on the exterior surface of the filter cup is provided with two markings 9A, 9B.

This film that can also be referred to as a label is introduced in the method step S2 into an injection mold or a die. In this connection, the plastic film is positioned where the labeling surface is to appear on the workpiece to be produced. FIG. 3B shows as an example a cylindrical mold 10, for example, made of metal, with opening 11. Through opening 11 the printed film 8 can be introduced and then positioned. For example, this can be done in case of polyamide films by suction produced by an appropriate vacuum device and positioning in the interior of the mold 10.

In the in-mold labeling (IML) process, in the subsequent step S3 the injection molding step is carried out. This means that hot plastic material is injected into the mold onto the printed label 8. This is illustrated in FIG. 3C in cross-section. The hot thermoplastic material contacts the mold wall of the mold 10 and forms the filter cup 2. Simultaneously, the material of the plastic film with the label 9 and the plastic material of the filter cup 2 join or fuse. In this way, in the manufacturing step of the filter cup 2 in the form of a plastic cup, a labeling surface results on the exterior side by means of the plastic film 8 provided with markings.

In the subsequent step S4 the filter element and the filter lid are installed on the filter cup. In the FIG. 3D this is shown in cross-section in a schematic way. In the filter cup 2 provided with the labeling surface 8 and the markings 9a, 9b, the filter element 4 and the filter lid 3 have already been inserted. In order to close off the interior of the filter cup 2 it is possible to weld for example at the sections 7 indicated by the arrows the filter cup 2 to the filter lid 3. This is done in step S5. Particularly laser welding has been found to be advantageous in this connection. Also, the plastic material from which the filter cup 2 and the filter 3 are manufactured can be colored with suitable pigments.

Finally, as illustrated in FIG. 3E, the filtering device 1 provided on the exterior side of the filter cup 2 with the labeling surface 8 with markings 9 is complete. As has already been explained in connection with FIG. 1, in an embodiment as a disposable oil filter the motor oil to be purified can flow through the openings 6 into the interior, pass through the filter element 4, and exit as purified motor oil through the central opening 5.

The introduction of the film in the step S2 can be done, for example, by a robot that takes a film from a prearranged stack of appropriate plastic films 8 and inserts it into a pre-centering station. By means of a gripping device the robot picks up the film from the pre-centering station and places it into a gripping device that is embodied as a negative mold relative to the filter cup. In the corresponding gripping device the film is secured, for example, by vacuum and is then inserted into the mold, as illustrated in FIG. 3B. The mold can be provided, for example, with vacuum grooves so that the film is secured in the desired position until the melted plastic material is introduced by injecting the hot plastic material.

The labeling or marking done by in-mold labeling has a series of advantages. For example, an undistorted image and heat-resistant print results. In that the print or the markings 9A, 9B can be applied to the inner side of the label, i.e., facing toward the injected plastic material, an excellent chemical resistance of the markings is provided. The markings thus are created between the plastic film and the material of the filter cup.

Even though the present invention has been explained in detail with the aid of preferred embodiments, the invention is not limited to the disclosed embodiments but can be modified in many ways. In particular the shape of the filtering device can be matched to the requirements of a particular application. Even though the invention has been explained in connection with a disposable oil filter, the filtering device can also be implemented for filtering other fluids.

The aforementioned materials have been mentioned only as examples wherein in principle any thermoplastic material can be used that is suitable for injection molding as well as for producing the plastic film with markings as well as for producing the filter cup. The illustrated shape and embodiment of the filtering device is only schematically illustrated. Further elements, for example, seals, reinforcement webs or other supplementary parts are also conceivable.

While the best modes for carrying out the invention have been described in detail, those familiar with the art to which this invention relates will recognize various alternative designs and embodiments for practicing the invention within the scope of the appended claims.

1. A filtering device comprising:
a filter cup made from plastic material,
a filter element inserted into said filter cup;
a filter lid closing off said filter cup;
at least one labeling surface provided on said filter cup, wherein said least one labeling surface is a plastic film provided with at least one labeling and is applied to said filter cup by in-mold labeling.

2. The filtering device according to claim 1, wherein said at least one labeling surface is provided on an exterior side of said filter cup.

3. The filtering device according to claim 1, wherein said at least one labeling is selected from a type designation, mounting instructions for the filtering device, a trade name, a trademark, and a manufacturer label.

4. The filtering device according to claim 1, wherein said at least one labeling is multi-colored.

5. The filtering device according to claim 1, wherein said at least one labeling is a hologram or an integrated electronic chip.

6. The filtering device according to claim 1, wherein said filter cup and said filter lid are welded together.

7. The filtering device according to claim 1, wherein said plastic material is laser-transparent.

8. The filtering device according to claim 1, wherein said plastic material is resistant relative to operating liquids of a motor vehicle.

9. The filtering device according to claim 1, in the form of a disposable oil filter or a disposable fuel filter.

10. The filtering device according to claim 1, wherein at least one of said plastic material and said plastic film is comprised of polyamide.

11. A method for producing a filtering device according to claim 1, the filtering device comprising a filter cup, a filter lid, and a filter element, the method comprising the step of:
providing at least one labeling surface with at least one labeling on the filter cup by in-mold labeling.

12. The method according to claim 11, further comprising the steps of:
introducing a plastic film as said at least one labeling surface into a mold for the filter cup;
injecting a plastic material into the mold for molding the filter cup; and
fusing the injection molded plastic material and the plastic film with one another.

13. The method according to claim 12, further comprising the steps of:
inserting the filter element into the filter cup; and
closing off the filter cup by the filter lid.

14. The method according to claim 13, further comprising the step of welding the filter cup and the filter lid together.

15. The method according to claim 14, wherein the step of welding is carried out by laser welding.

16. The method according to claim 12, further comprising the step of securing the plastic film by electrostatic charging or by vacuum in a desired position in the mold.

17. The method according to claim 12, wherein the at least one labeling is selected from a type designation, mounting instructions for the filtering device, a trade name, a trade mark, and a manufacturer label.
